(19) United States
(12) Patent Application Publication
(10) Pub. No.: US 2021/0170934 A1
(43) Pub. Date: Jun. 10, 2021

(54) Mobile Lighting System

(71) Applicant: Kevin Arnold Morran, Port Alberni (CA)

(72) Inventor: Kevin Arnold Morran, Port Alberni (CA)

(21) Appl. No.: 17/178,960

(22) Filed: Feb. 18, 2021

Related U.S. Application Data
(63) Continuation of application No. 16/253,138, filed on Jan. 21, 2019, now abandoned.
Application No. 16/253,138 is a continuation-in-part of application No. 17/089,843, filed on Nov. 5, 2020.

(51) Int. Cl. B60P 3/18; F21V 21/15; F21V 21/26; G05D 1/00; B60L 50/60; B60Q 1/24; B62D 55/06

(52) U.S. Cl. CPC B60P 3/18; F21V 21/15; F21V 21/26; B62D 55/06; B60L 50/60; B60Q 1/245; G05D 1/0094; G05D 1/0011

(57) ABSTRACT

A mobile lighting system having a mobile platform assembly configured to traverse across a surface in response to remotely generated command signals from a portable electronic device and a lighting assembly mounted to the mobile platform assembly. The lighting assembly configured to provide illumination. The lighting assembly having at least one light source to provide the illumination and at least one mounting arm having the at least one light source mounted thereto. The at least one mounting arm having at least one pivotable joint configured to allow for directional control of the illumination. The mobile platform assembly having a mobile platform, a transportation assembly connected to the mobile platform. The transportation assembly configured to provide movement to the mobile platform assembly. A control assembly having a receiver is configured to receive remotely generated command signals from the remote controller. The control assembly configured to control the transportation assembly and the mounting arm in response to the signals.

### REFERENCE TO PENDING APPLICATIONS

This application claims the benefit of U.S. patent application Ser. No. 16/253,138 entitled Remote Controlled Lighting Apparatus, filed Jan. 21, 2019, and U.S. patent application Ser. No. 17/089,843, entitled Remote Controlled Lighting Apparatus, filed Nov. 5, 2020.

### TECHNICAL FIELD

The present invention relates generally toward a mobile light, and more specifically, toward a self-propelled mobile light.

### BACKGROUND

In the construction and home repair industry. The ability to illuminate a working area can be critical. Typically, a tradesman will set a light to illuminate the specific area so that the necessary work can be accomplished. For example, a plumber may need to work in an area having poor illumination. The plumber may erect a light on a pole or other stand to direct illumination from a light source to the area upon which the plumber needs to conduct his work. In such a situation, the light source is powered by a power cord that extends from an electrical outlet to the light source.

However, there are challenges to the above situation. The area upon which the tradesman may need to work may be larger than the area upon which the light can illuminate.

In such a situation the tradesman is required to either provide additional lighting structures to increase the lighting capability or move an existing lighting structure to accommodate the workspace needed. Both of these solutions have disadvantages. The providing additional lighting structures is costly and requires an extensive amount of additional equipment by the tradesman. Moving the existing lighting structures requires the tradesman to disassemble and otherwise tear down the existing lighting structure and relocating it to the new location, including redeploying the power cord. At times the new location may be at a distance away and can cause the tradesman to spend time and energy to disassemble and relocate the lighting structure to the new desired location.

Accordingly, there is a need to satisfy the challenges as set out above.

### SUMMARY

The present invention relates generally toward a mobile light, and more specifically, toward a self-propelled mobile light.

In one aspect, a mobile lighting apparatus for use with an associated remote controller that generates commands is disclosed. The mobile lighting apparatus has a mobile platform assembly that is configured to traverse across a surface in response to remotely generated command signals from the remote controller. The mobile lighting apparatus also having a lighting assembly mounted to the mobile platform assembly. The lighting assembly is configured to provide illumination.

In some aspects, the mobile platform assembly has a mobile platform, and a transportation assembly connected to the mobile platform. The transportation assembly is configured to provide movement to the mobile platform assembly. The mobile platform assembly further has a control assembly having a receiver configured to receive remotely-generated command signals from the remote controller. The control assembly can be configured to control the transportation assembly in response to the signals.

In some aspects, the transportation assembly has a wheel assembly connected to the mobile platform. The wheel assembly is configured to provide movement to the mobile platform assembly. The transportation assembly further has a power assembly configured to provide power to the wheel assembly. The power assembly may have a motor and a battery with the motor configured to provide battery power to the wheel assembly.

In some aspects, the wheel assembly may have a plurality of wheels rotatably connected to the mobile platform. Further, the wheel assembly may also have at least two treads where each of the at least two treads extending between at least two of the plurality of wheels.

In some aspects, the lighting assembly has at least one light source which provides illumination, and at least one mounting arm having the at least one light source mounted thereto.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a side perspective view of a schematic representation of an embodiment of the present invention.

FIG. 2 is a side perspective view of a schematic representation of an embodiment of the present invention with the light structure in a deployed position.

FIG. 3 is a front perspective view of a schematic representation of an embodiment of the present invention with the light structure in a deployed position.

FIG. 4 is a side perspective view of a schematic representation of an additional embodiment of the present invention.

FIG. 5 is a schematic diagram of an embodiment of the present invention.

FIG. 6 is a schematic diagram of an additional embodiment of the present invention.

FIG. 7 is a side perspective view of a schematic representation of an additional embodiment of the present invention.

### DETAILED DESCRIPTION OF THE INVENTION

The present invention is directed toward a compact, self-propelled mobile light. This device would be able to maneuver to various locations, including small or tight to fit locations, to provide illimitation exactly where it is needed for trades people, home owners, emergency responders, especially in tight spaces and controlled by a very small wireless remote.

One of the features of the present invention is the ability to eliminate the need to redeploy work light that is powered through the use of a power cord to a desired location. The present invention provides effective lighting in many situations, such as where a task is constantly moving such as painting, wiring plumbing, concrete, crawl spaces, exterior work, elevated work, hard to get to areas where lighting is essential.

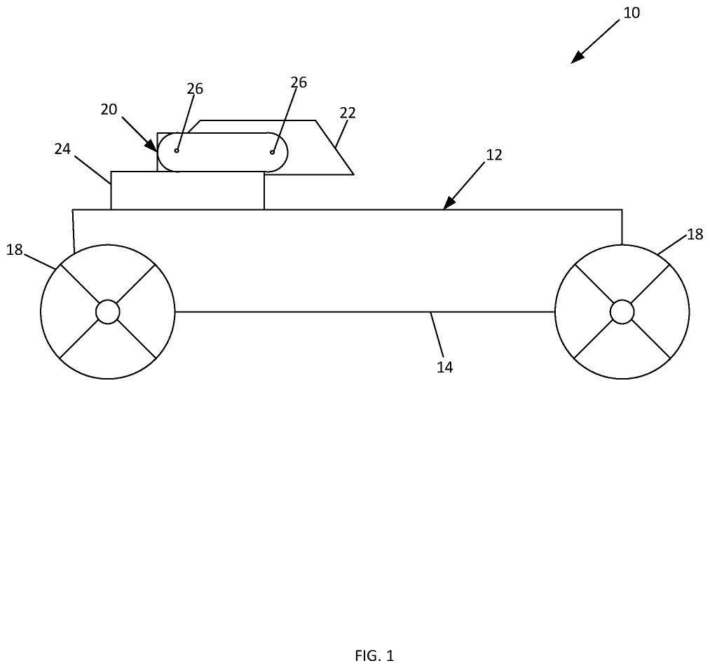

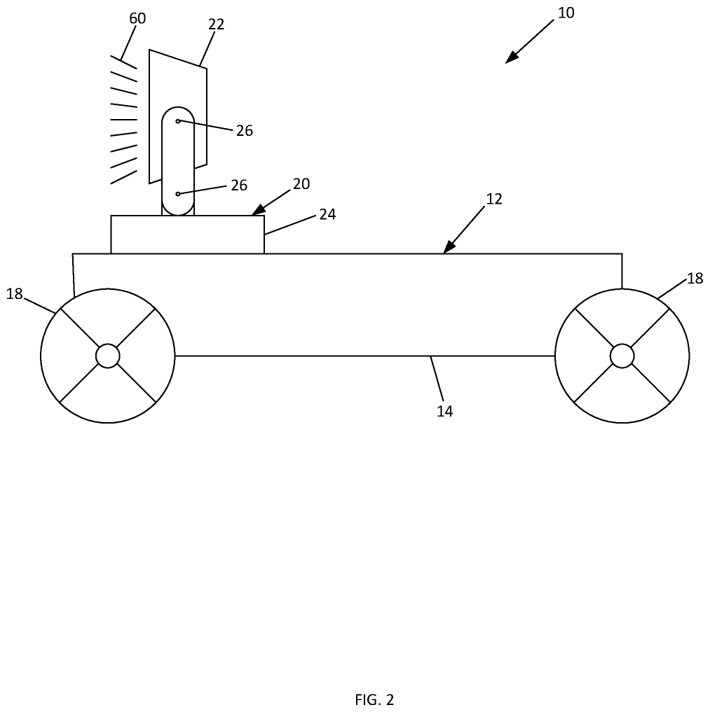

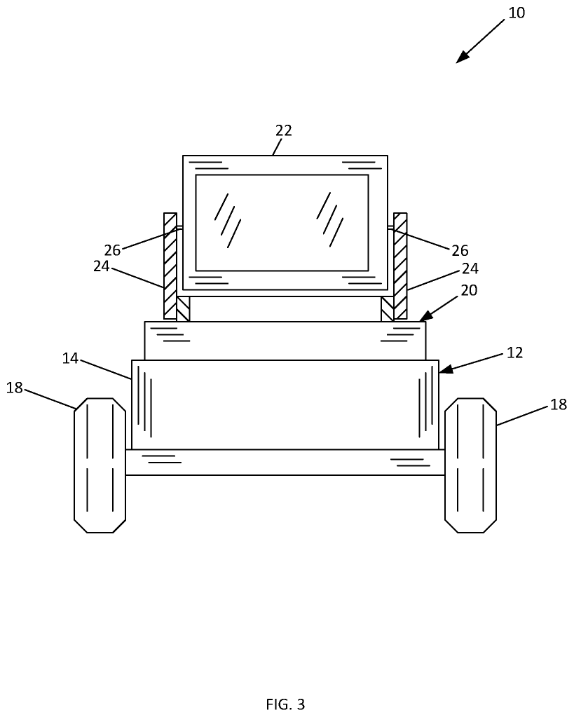

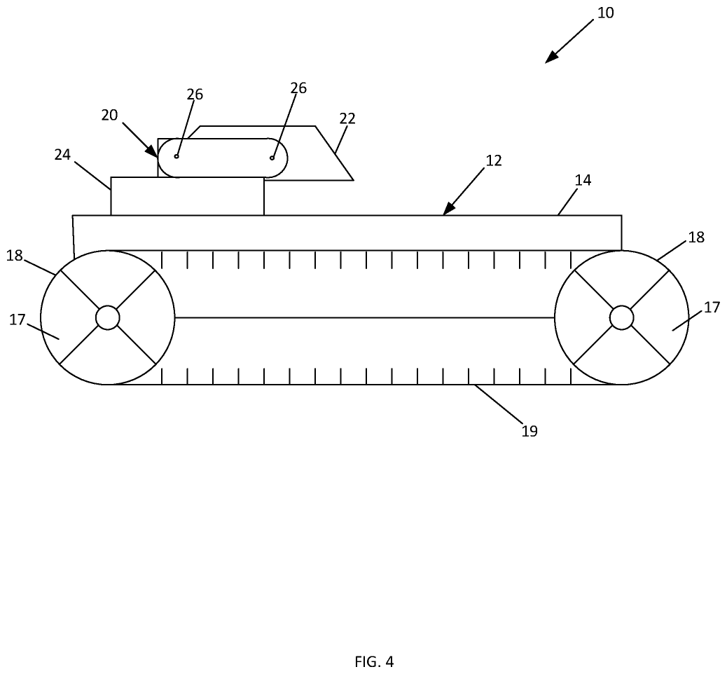

As illustrated in FIGS. 1-4, an embodiment of a mobile lighting apparatus 10 is disclosed. The mobile lighting apparatus 10 is used with an associated remote controller 50 that generates command signals. The mobile lighting apparatus 10 includes a mobile platform assembly 12 that is configured to traverse across a surface in response to the remotely generated command signals from the remote controller 50. Apparatus 10 also has a lighting assembly 20 mounted to the mobile platform assembly 12. The lighting assembly 20 is configured to provide illumination to desired areas.

Lighting assembly 20 may have at least one light source 22 which provides the illumination and at least one mounting arm 24. The mounting arm is mounted to the mobile platform assembly 12 and is capable of having the light source 22 mounted thereto. In order to provide directional control of the illumination 60, the mounting arm 24 has at least one pivotable joint 26. The directional movement capability of mounting arm 24 includes the rotation, panning and tilting capability of the light source 22. For example, mounting arm 24 may allow for the rotation of 360° relative to the mobile lighting assembly 12 and the tilting of 180° of the light source relative to the mounting arm 24. Lighting assembly 20 may also capable of being collapsed or folded down flat against the mobile platform assembly 12 for protection and portability when not in use, see FIG. 1.

In some embodiments, the light source may be a light emitting diode (LED) based light, and may have variable brightness settings, such as low, medium and high brightness settings. However, those skilled in the art will recognize that any light bulb or related light source, along with the variable light settings, may be used with the lighting assembly 20 and would be within the scope of the present invention.

In some embodiments, mobile platform assembly 12 includes a mobile platform 14 and a transportation assembly 16 connected to the mobile platform 14. The transportation assembly 16 provide the movement capability to the mobile platform assembly 12. In some embodiments, the overall size of the mobile platform assembly 12 is between one (1) and three (3) feet square in dimension. In such embodiments, light assembly 20 would be sized to fit within the dimensions of mobile platform assembly 12.

Transportation assembly 16 may include a wheel assembly 18 connected to the mobile platform and provides movement to the mobile platform assembly 12. Wheel assembly 18 may include a plurality of wheels 17 rotatably connected to the mobile platform. While the Figures illustrate the use of four tires, two per side, this number is merely illustrative and not meant to be limiting. Those skilled in the art will recognize that additional configurations having a different number of wheels, such as six or eight, is within the scope of the present invention. Further, wheel assembly 18 may include at least two treads 19 extending between at least two of the plurality of wheels 17. These configurations allow for either an all treaded wheel assembly or a combination wheel/tread wheel assembly. The various configurations may allow for apparatus 10 to be traversed over various surfaces ranging from smooth surfaces to rough surfaces having obstacles, such as small, e.g. pieces of lumber, in the pathway of apparatus 10.

Transportation assembly 16 also includes a power assembly 32 configured to provide power to the wheel assembly 18. The power assembly 32 includes a motor 36 and a battery 38. Battery 38 can be rechargeable and removable. Transportation assembly 16 is also configured to provide variable speeds, such as slow to fast, and directional capability, such as right turn, left turn and reverse, to apparatus 10.

In some embodiments, mobile platform assembly 12 also has a control assembly 30 that is configured to control the operations of apparatus 10. Control assembly 30 may at least one processor 36 and at least one memory storage device 38. Further, control assembly 30 may have a receiver 34 configured to receive remotely-generated command signals from the remote controller 50. The control assembly 30 configured to control the transportation assembly 16 and lighting assembly 20 in response to those signals.

In some embodiments, remote controller 50 may be a handheld remote control device having two or more toggles levers. In other embodiments, remote controller 50 may be a software application located on a user's smartphone. Still in other embodiments, remote controller 50 may be a homing type of device that can be attached to the user belt or clothing. In such embodiments, apparatus 10 may move toward the user as the user walks in a direction. This allows for an area to be illuminated by apparatus 10 while the user walks around a work site without the need for manual movements commands from the user.

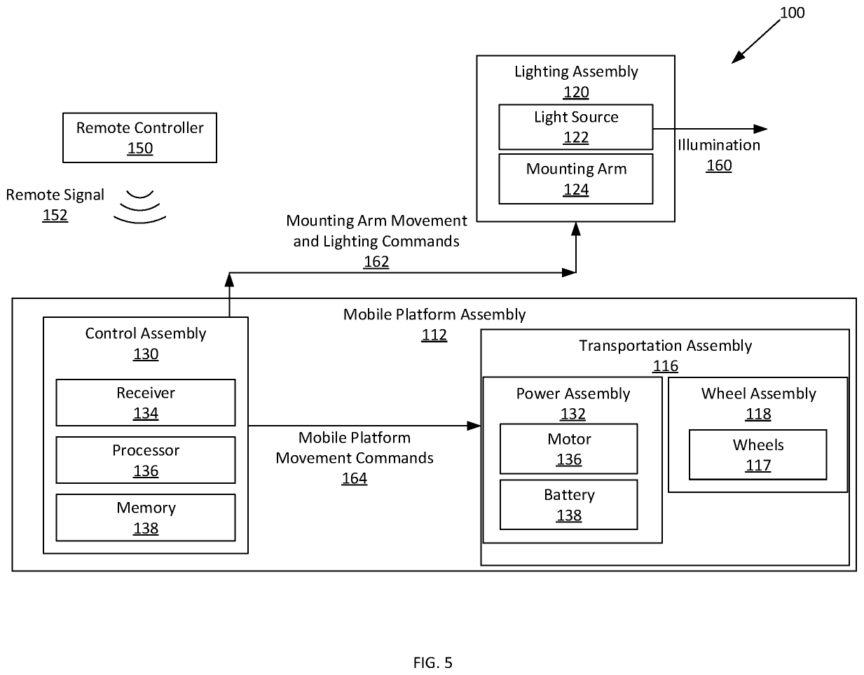

As illustrated in FIG. 5, a schematic representation of an embodiment 100 of the present invention is disclosed. Embodiment 100 includes a mobile platform assembly 112 and a lighting assembly 120 mounted to mobile platform 112.

Lighting assembly 120 includes a light source 122 mounted to a mounting arm 124. As set out above, light source 120 produces illumination 160 which can be directed to a specific location.

Mobile platform assembly 112 operates as set out above and has a control assembly 130 and a transportation assembly 116. Transportation assembly 116 operates as set out above as it provides movement capability to mobile platform assembly 112. Movement by transportation assembly is provided by a power assembly 132 and a wheel assembly 118. Power assembly 132 has a motor 136 and a battery 138 provides movement to the wheel assembly 118 wherein a plurality of wheels 117 act on that movement in order to move mobile platform assembly 112.

Control assembly 130 has a receiver 134, at least one processor 136 and at least one memory device 138. Control assembly 130, through receiver 134, is configured to receive remote signals 152 from a remote controller 150. The remote signals 152 may be stored in memory device 138 and processed by processor 136. The remote signals 152 may be commands to direct one or more aspects of embodiment 100 to move in a direction or to increase or decrease illumination 160. For example, commands regarding the movement of mobile platform assembly may be received by receiver 134. Control assembly 130 may send mobile platform movement commands 164 to transportation assembly 116, which in turn acts on these commands and moves mobile platform assembly 112 accordingly. Further, commands regarding the movement of lighting assembly 120 and to increase the illumination 160 from light source 122 may be received by receiver 134. Control assembly 130 may send mounting arm movement and lighting commands 162 to lighting assembly 120, which in turn acts on these commands and moves lighting assembly 120 and increases the illumination 160 produced by light source 122 accordingly.

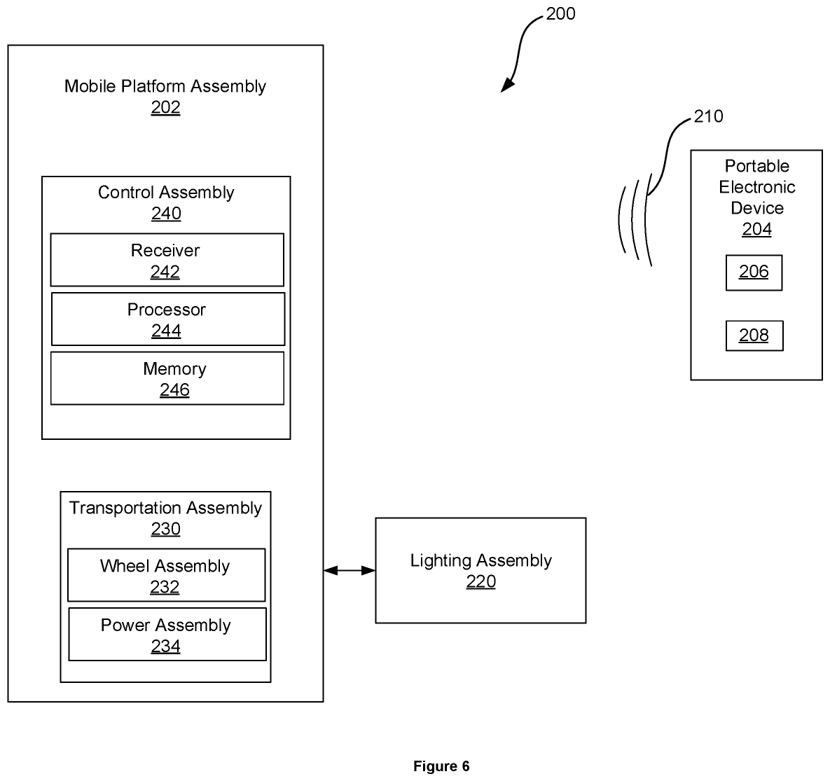

As illustrated in FIG. 6, an schematic illustration of an embodiment of a mobile lighting system 200 of the present invention is disclosed. The mobile lighting system 200 includes a mobile platform assembly 202 that is configured as previously set out, namely being able to traverse across a surface.

Mobile platform assembly 202 is in near-field short distance wireless communication with a portable electronic device (PED) 204. The PED 204 having at least one transmitter 206 and at least one processor 208, the PED configured to transmit command signals 210 to the mobile platform assembly 202. The PED can be a smart phone or a tablet type of device. One type of near-field short distance wireless communication standard is Bluetooth. Bluetooth is a wireless technology standard used for exchanging data between fixed and mobile devices over short distances using UHF radio waves in the industrial, scientific and medical radio bands, from 2.402 GHz to 2.480 GHz, and building personal area networks (PANs).

Mobile platform system 200 also includes a lighting assembly 220 mounted to the mobile platform assembly 202. The lighting assembly 220 is configured to provide illumination and directional control of the illumination.

In further embodiments, the mobile platform assembly 202 has a transportation assembly 230 configured to provide movement to the mobile platform assembly 202. The transportation assembly 230 can include a wheel assembly 232 and power assembly 234.

In further embodiments, the mobile platform assembly 202 has a control assembly 240 having a receiver 242, at least one processor 244, and at least one memory device 246. The control assembly 240 is configured to receive the command signals 210 from the PED 204. In response to these received command signals 210, the control assembly 240 is configured to control the transportation assembly 230, to increase or decrease the illumination of the lighting assembly 220 and to reposition the direction of the illumination of the lighting assembly 220.

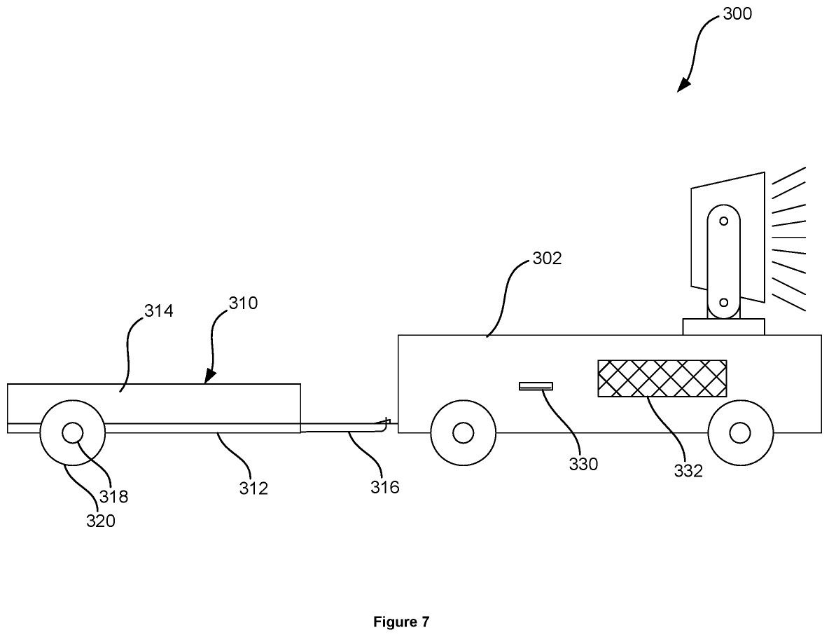

As illustrated in FIG. 7, an additional embodiment of a mobile lighting system 300 of the present invention is disclosed. The mobile lighting system 300 includes a mobile platform assembly 302 as previously disclosed. Further, the mobile lighting system 300 includes a trailer 310. The trailer 310 includes a trailer frame 312 which supports a trailer bed 314 upon which a load, e.g. tools, etc., rests. A draw bar 316 connects the trailer frame 312 to a mobile platform assembly 302. The trailer 310 further includes a stub axle 318 having an associated wheel 320. The ability to hold tools and other items allows a tradesman to move and work more efficiently within a workspace. Couple this capability with the ability to illuminate a specific area of a workspace, the tradesman is able to perform his work in a more efficient manner than in prior situations where he would be required to leave the workspace to obtain a needed tool. The trailer 310 shown in FIG. 7 has one pair of wheels mounted on stub axles, however other wheel arrangements such as tandem axles lie within the scope of the invention.

In some embodiments, mobile platform assembly 302 further includes at least one portable electronic device charge port 330 configured to provide power to the PED or another portable electronic device. In still other embodiments, mobile platform assembly 302 further includes at least one built-in speaker 332 and configured to broadcasts received audio signals from the PED.

While this embodiment discloses movement and lighting commands for the mobile platform assembly and lighting assembly, such commands are merely illustrative. Those skilled in the art will recognize that other commands may be received, processed and acted upon, and such other commands are within the scope of the present invention.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

1. A mobile lighting system comprising:
a mobile platform assembly in near-field short distance wireless communication with a portable electronic device (PED), the PED having at least one transmitter and at least one processor, the PED configured to transmit command signals to the mobile platform assembly; and
a lighting assembly mounted to the mobile platform assembly, the lighting assembly configured to provide illumination and directional control of the illumination
the mobile platform assembly having
a mobile platform;
a transportation assembly connected to the mobile platform, the transportation assembly configured to provide movement to the mobile platform assembly, and
a control assembly having a receiver, at least one processor, and at least one memory device, the control assembly configured to receive the command signals from the PED and in response to the received command signals the control assembly configured to control the transportation assembly, to increase or decrease the illumination of the lighting assembly, and to reposition the direction of the illumination of the lighting assembly.

2. The mobile lighting system of claim 1, wherein the PED is a smart phone.

3. The mobile lighting system of claim 1, wherein the PED is a tablet device.

4. The mobile lighting system of claim 1, wherein the transportation assembly comprises:
a wheel assembly connected to the mobile platform, the wheel assembly configured to provide movement to the mobile platform assembly; and
a power assembly configured to provide power to the wheel assembly.

5. The mobile lighting system of claim 4, wherein the power assembly comprising:
a motor; and
a battery, the motor configured to provide battery power to the wheel assembly.

6. The mobile lighting system of claim 4, wherein the wheel assembly comprising:
a plurality of wheels rotatably connected to the mobile platform.

7. The mobile lighting system of claim 4, wherein the wheel assembly comprising:
a plurality of wheels rotatably connected to the mobile platform; and
at least two treads, each of the at least two treads extending between at least two of the plurality of wheels.

8. The mobile lighting system of claim 1, wherein the lighting assembly comprising:
at least one mounting arm having the at least one light source mounted thereto, the at least one mounting arm being mounted to the mobile platform assembly, the at least one mounting arm having at least one pivotable joint configured to allow for directional control of the illumination; and
at least one light source mounted to the at least one mounting arm, the at least one light source providing illumination.

9. The mobile lighting system of claim 1, further comprising:
a trailer, the trailer having
a draw bar;
a trailer frame supporting a trailer bed; and
a trailer wheel assembly having a plurality of trailer wheels rotatably connected to the trailer frame.

10. The mobile lighting system of claim 1, wherein the mobile platform assembly further comprising at least one portable electronic device charge port configured to provide power to the PED or another portable electronic device.

11. The mobile lighting system of claim 1, wherein the mobile platform assembly further comprising at least one built-in speaker and configured to broadcasts received audio signals from the PED.
